(19) United States
(12) Patent Application Publication
(10) Pub. No.: US 2025/0353220 A1
(43) Pub. Date: Nov. 20, 2025

(54) FILLET SHAPING DIE AND BONDING METHOD

(71) Applicant: TOYOTA JIDOSHA KABUSHIKI KAISHA, Toyota-shi (JP)

(72) Inventor: Akihiro TERASAKA, Toyota-shi (JP)

(73) Assignee: TOYOTA JIDOSHA KABUSHIKI KAISHA, Toyota-shi (JP)

(21) Appl. No.: 19/026,515

(22) Filed: Jan. 17, 2025

(30) Foreign Application Priority Data
May 17, 2024 (JP) 2024-080760

(51) Int. Cl. B29C 33/42; B29C 65/54

(52) U.S. Cl. CPC B29C 33/42; B29C 65/54

(57) ABSTRACT

The fillet shaping die includes a fillet shaping face disposed in abutment with the first member, the fillet shaping face having a curved face that forms a fillet of adhesive at a corner formed by the first member and a second member bonded by the first member and the adhesive.

### CROSS-REFERENCE TO RELATED APPLICATION

This application claims priority to Japanese Patent Application No. 2024-080760 filed on May 17, 2024, incorporated herein by reference in its entirety.

### BACKGROUND

### 1. Technical Field

The present disclosure relates to a fillet shaping die and a bonding method.

### 2. Description of Related Art

Conventionally, control of a fillet shape has been attempted when two members are bonded using an adhesive that is made of a resin material. For example, in Japanese Unexamined Patent Application Publication No. 2000-260791 (JP 2000-260791 A), the shape of a fillet is controlled by adjusting a supply amount of the resin material for a purpose of sealing a gap between the two members, using a through hole that has a buffer function.

### SUMMARY

However, even when the amount of the resin material that is supplied to the gap is adjusted, the shape of the fillet may vary depending on characteristics such as viscosity of the resin material.

The present disclosure can be realized in the following aspects.
(1) According to a first aspect of the present disclosure, a fillet shaping die is provided. The fillet shaping die includes a fillet shaping face that is disposed abutting a first member, and the fillet shaping face includes a curved face that shapes a fillet of an adhesive at a corner that is created by the first member and a second member that is bonded to the first member by the adhesive. According to this aspect, disposing the fillet shaping die in an orientation in which the fillet shaping face abuts the first member enables positional deviation of the fillet shaping die with respect to the first member to be suppressed, and reduce variance in the shape of the fillet that is formed in the adhesive. Accordingly, stress concentration in the bonding portion between the first member and the second member can be suppressed, and bonding strength between the first member and the second member can be improved.
(2) The fillet shaping die of the above aspect may include a counter face that is connected to the fillet shaping face, and that abuts the second member, in which the fillet shaping die is fashioned extending in a direction in which the corner extends, and a shape of the fillet shaping face may be arcuate in a side view of the fillet shaping die, as viewed in the direction in which the corner extends. According to this aspect, the counter face abutting the second member enables positional deviation between the fillet shaping die and the second member to be suppressed, and variance in the shape of the fillet that is formed in the adhesive can be further reduced. Further, when the bonding portion between the first member and the second member extends linearly, the fillet can be efficiently formed at the bonding portion. Also, the cross-sectional shape of the fillet can be made to be arcuate, and accordingly the bonding strength can be further improved.
(3) In the fillet shaping die of the above aspect, the counter face may include a first side that is connected to the fillet shaping face, a second side on an opposite side from the first side, and a groove extending from the first side to the second side. According to this aspect, excess adhesive is guided to the second side along the groove, and accordingly excess adhesive can be suppressed from adhering to the first member or the second member.
(4) According to a second aspect of the present disclosure, there is provided a bonding method for bonding a first member and a second member using a fillet shaping die. The fillet shaping die includes a fillet shaping face and a counter face that is connected to the fillet shaping face. The bonding method includes a first step of disposing an adhesive on the first member, a second step of disposing the fillet shaping die and the second member with respect to the first member on which the adhesive is disposed, such that the fillet shaping face abuts the first member and also the counter face abuts the second member, and a third step of separating the fillet shaping die from the first member and the second member after the adhesive is cured and the first member and the second member are bonded to each other. According to this aspect, variance in the shape of the fillet that is formed in the adhesive can be reduced. Accordingly, stress concentration in the bonding portion between the first member and the second member can be suppressed, and bonding strength between the first member and the second member can be improved.
(5) In the bonding method of the above aspect, in the second step, the fillet shaping die may be temporarily fixed such that the fillet shaping face abuts the first member, following which the second member is brought closer to the first member on which the adhesive is disposed until the second member abuts the counter face. According to this aspect, temporarily fixing the fillet shaping die enables positional accuracy of the second member with respect to the first member to be improved.

The present disclosure can be realized in various forms other than those described above. For example, realization can be made in a form of a method of manufacturing a shaped fillet article or the like.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a fillet shaping die;

FIG. 2 is a cross-sectional view illustrating the bonding step;

FIG. 3 is a view for explaining the bonding step of the second embodiment; and

FIG. 4 is a diagram illustrating a fillet shaping die according to a third embodiment.

### DETAILED DESCRIPTION OF EMBODIMENTS

### A. First Embodiment

### A1. Fillet Shaping Die

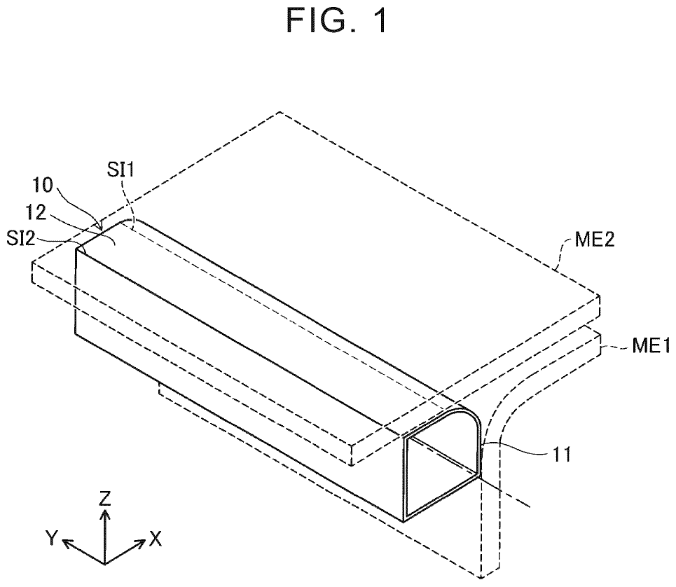

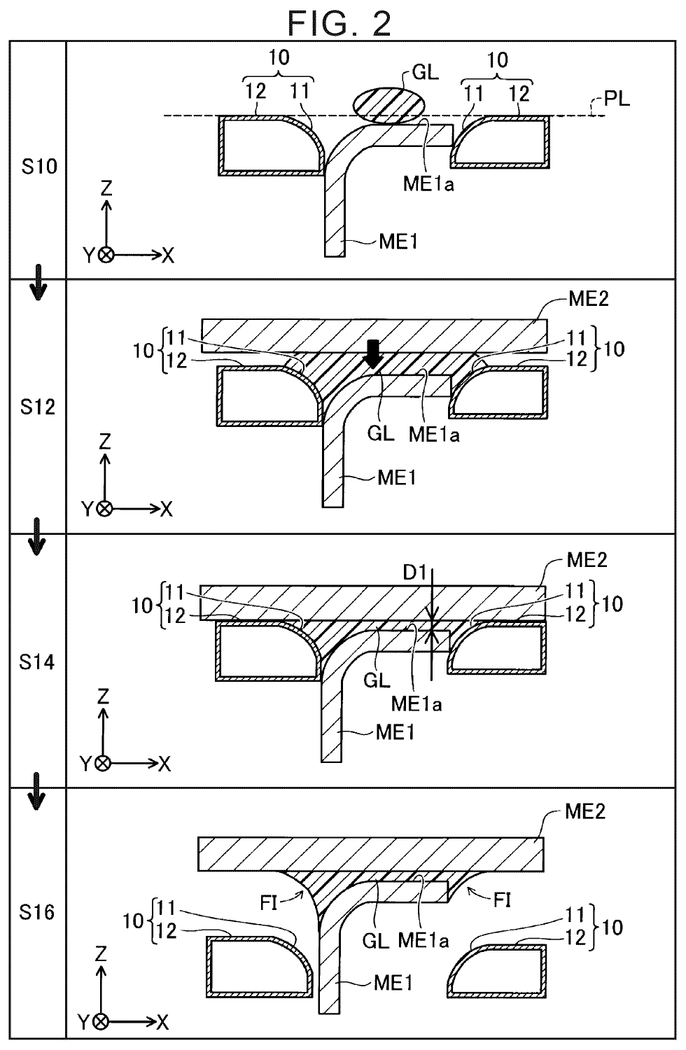

FIG. 1 is a perspective view of a fillet shaping die 10. FIG. 2 is a cross-sectional view illustrating a bonding step between the first member ME1 and the second member ME2. As shown in “S16” of FIG. 2, the fillet shaping die 10 is used to form a fillet FI in an adhesive GL for bonding the first member ME1 and the second member ME2. In the present disclosure, the fillet FI is a shape of an end portion of the adhesive GL, and is a shape having a curved face. In FIG. 1, arrows indicating X, Y, Z orientations perpendicular to each other are shown. The Z direction is a direction along the vertical upward direction. The arrows indicating X, Y, Z direction are also shown in other figures as appropriate so that the direction shown corresponds to FIG. 1. In the following explanation, in the case of identifying the direction, the direction indicated by the arrow in each figure is “+” and the opposite direction is “−,” and the positive and negative signs are used in conjunction with the direction indication. Hereinafter, the +Z direction is also referred to as “up”, and −Z direction is also referred to as “down”.

As shown in FIG. 1, the fillet shaping die 10 includes a fillet shaping face 11 and a counter face 12 connected to the fillet shaping face 11. The fillet shaping die 10 of the present embodiment has a cylindrical shape extending in the axial direction. The fillet shaping face 11 is a surface that is disposed so as to abut the first member ME1 in a bonding step to be described later. The counter face 12 is a surface that is disposed so as to abut the second member ME2 in the bonding step described later. The fillet shaping face 11 has a curved face for forming a fillet FI of an adhesive GL at a corner formed by the first member ME1 and the second member ME2. In the present embodiment, the entire area of the fillet shaping face 11 is a curved face for forming the fillet FI of the adhesive GL at the corner formed by the first member ME1 and the second member ME2. In the present embodiment, the counter face 12 is a substantially flat surface.

The counter face 12 has a first side SI1 connected to the fillet shaping face 11 and a second side SI2 opposed to the first side SI1. In FIG. 1, the first side SI1 is indicated by a broken line. As shown in “S10” of FIG. 2, the shape of the fillet shaping face 11 in a side view of the fillet shaping die 10 viewed along the axial direction is an arc. Generally, it is known that when the cross-sectional shape of the fillet FI is an arc, the bonding strength is improved. Therefore, since the fillet shaping face 11 has an arc shape in a side view, the bonding strength between the first member ME and the second member ME2 can be improved.

In the bonding step described later, after the adhesive GL is cured, the fillet shaping die 10 is separated from the cured adhesive GL. Therefore, the fillet shaping die 10 is preferably made of a material that is easily detached from the adhesive GL after curing. Specifically, a form in which a mold release agent is applied to the surface of a fillet shaping die 10 made of metal such as iron, or a form in which a layer of a fluororesin such as polytetrafluoroethylene is formed on the surface of the fillet shaping die 10 made of metal can be used.

### A2. Bonding Step

With reference to FIG. 2, an example in which two fillet shaping dies 10 are used to bond the first member ME1 and the second member ME2 having the shapes shown in FIG. 2 will be described, and an example of the bonding step for realizing the bonding method will be described. In FIG. 2, a cross section is shown in which a plane perpendicular to the axial direction of the fillet shaping die 10 is a cut plane. As shown in FIG. 1, the first member ME1 is an L-shaped member in which the front end of the flat plate is bent. The second member ME2 is a flat plate. In the present embodiment, the material of the first member ME1 and the second member ME2 is a carbon-fiber composite material.

The shape of the fillet shaping die 10 is manufactured in accordance with the respective shapes of the first member ME1 and the second member ME2. As shown in FIG. 1, in the present embodiment, the corner formed by the first member ME1 and the second member ME2 extends linearly. Therefore, the fillet shaping die 10 of the present embodiment has a shape extending in the axial direction parallel to the direction in which the corner extends. The shape of the fillet shaping face 11 in a side view viewed along the 15 axial direction of the fillet shaping die 10, which is the direction in which the corner extends, is an arc.

As shown in the “S10” of FIG. 2, in S10, the fillet shaping face 11 of each of the two fillet shaping dies 10 is arranged to abut the first member ME1 at a desired position. Here, the desired position is a position where the distance D1 between the bonding face ME1a of the first member ME1 on which the adhesive GL is disposed and the second member ME2 is a desired distance, as shown in “S14” of FIG. 2. The desired position is a position where the fillet shaping faces 11 abut against the first member ME1. The distance D1 is the thickness of the adhesive GL when the first member ME1 and the second member ME2 are bonded to each other. In S10, the two fillet shaping dies 10 are positioned such that the distance between the virtual plane PL including the respective counter faces 12 of the two fillet shaping dies 10 and the bonding face ME1a is the desired distance. As a specific method of positioning, the following method can be used. A first flat plate (not shown) having a desired thickness is placed on the bonding face ME1a. A second flat plate (not shown) is laminated on the first flat plate. The fillet shaping die 10 is arranged so that the second flat plate and the counter face 12 face each other and come into contact with each other.

In S10, after the positioning of the two fillet shaping dies 10 is performed, the two fillet shaping dies 10 are temporarily fixed to the first member ME1. As a temporary fixing method, a method using a double-sided tape or a fastening member can be used. As a specific method, the fillet shaping die 10 may be provided with a temporary fixing portion for temporary fixing (not shown), and a method of fixing the temporary fixing portion with a double-sided tape or a fastening member attached thereto may be used. In S10, the adhesive GL is disposed on the bonding face ME1a after being temporarily fixed. The adhesive GL is arranged in a line along a direction parallel to the axial direction of the fillet shaping die 10. The adhesive GL may be arranged manually by the operator or may be arranged robotically.

The method of the temporary fixing is not limited to the above. For example, it may be temporarily fixed using a fixing tool separate from the fillet shaping die 10, the first member ME1, and the second member ME2.

In the present embodiment, a so-called two-component epoxy-resin is used as the adhesive GL. Specifically, an adhesive GL formed by mixing a first liquid and a second liquid containing epoxy resins as main components, the main components of which differ from each other, is disposed on the bonding face ME1a.

As indicated by “S12” in FIG. 2, in S12, the second member ME2 is disposed so as to face the respective counter faces 12 of the two fillet shaping dies 10. The second member ME2 is moved downward until abutting the counter face 12. In the process of moving the second member ME2 downward, the adhesive GL expands so as to fill the space surrounded by the first member ME1, the two fillet shaping dies 10, and the second member ME2. That is, the adhesive GL is shaped along the fillet shaping face 11. The amount of the adhesive GL disposed on the bonding face ME1a is set to be a sufficient amount to fill the space. The fillet shaping die 10 is arranged such that the fillet shaping face 11 is in contact with the first member ME1. Therefore, the adhesive GL is prevented from dripping from the part where the fillet shaping face 11 and the first member ME1 are in contact with each other. Therefore, it is possible to reduce the number of man-hours for cleaning the sagging adhesive GL. In the present embodiment, it is assumed that the excess adhesive GL hangs from the axial end of the fillet shaping die 10. Therefore, a container for receiving an extra adhesive GL may be disposed below the axial end of the fillet shaping die 10.

In S12, instead of the downward movement of the second member ME2, the first member ME1 may be moved upward so that the position in the Z direction approaches the second member ME2 that is fixed.

In the “S14” of FIG. 2, the adhesive GL hardens with the second member ME2 abutting the counter face 12. In the present embodiment, as described above, since the two-component epoxy resin is used, the adhesive GL is cured by a chemical reaction.

After the adhesive GL is cured and the first member ME1 and the second member ME2 are bonded, the two fillet shaping dies 10 are separated from the first member ME1 and the second member ME2 in the “S16” of FIG. 2. Specifically, the two fillet shaping dies 10 are removed from the first member ME1. As described above, the adhesive GL is formed along the fillet shaping face 11. Therefore, a fillet FI is formed on the cured adhesive GL. The fillet FI thus formed is formed by using the fillet shaping die 10, and thus has a uniform configuration.

The time when the two fillet shaping dies 10 are removed from the first member ME1 is not limited to the time when all of the adhesive GL is cured. For example, the fillet shaping die 10 may be removed when the depth of the adhesive GL is uncured and cured to such an extent that the face of the adhesive GL can retain the form of the fillet FI.

As a bonding method which is distributed, there is a method of scraping off an excessive adhesive GL of a corner formed by the first member ME1 and the second member ME2 with a spatula. However, when this process is employed, depending on the viscosity of the adhesive GL, the adhesive GL may sag due to gravitational force, or the fillet FI may be deformed. In this regard, according to the present embodiment, since the fillet shaping face 11 is disposed abutting the first member ME1, it is possible to suppress sagging of the adhesive GL from the part where the fillet shaping face 11 and the first member ME1 are in contact with each other. Further, according to the present embodiment, since the fillet FI is formed by the fillet shaping face 11, it is possible to form the fillet FI having a desired configuration regardless of the properties such as the surface tension and the viscosity of the adhesive GL. In addition, when the above-described circulating bonding methods are employed, the space is limited depending on the shapes of the first member ME1 and the second member ME2, and it may be difficult to obtain the bonding part between the first member ME1 and the second member ME2. In this regard, according to the present embodiment, it is possible to form the fillet FI when it is possible to secure a space into which the fillet shaping die 10 can be inserted even if it is not possible to secure a space for taking care.

According to the first embodiment described above, the fillet shaping die 10 includes the fillet shaping face 11. The fillet shaping face 11 has a curved face for forming a fillet FI of an adhesive GL at a corner formed by the first member ME1 and the second member ME2 which are bonded to each other. By using the fillet shaping die 10, it is possible to reduce variations in the shapes of the fillet FI formed on the adhesive GL because the fillet FI is formed on the adhesive GL by the fillet shaping face 11. Therefore, the bonding strength between the first member ME1 and the second member ME2 can be improved by suppressing the stress concentration in the bonding portion between the first member ME1 and the second member ME2. Further, since the fillet shaping face 11 abuts the first member ME1, the adhesive GL is prevented from dripping from a part where the fillet shaping face 11 and the first member ME1 are in contact with each other.

Further, the shape of the fillet shaping face 11 in a side view of the fillet shaping die 10 as viewed along the direction in which the corner formed by the first member ME1 and the second member ME2 extends is a circular arc. As a result, the cross-sectional profile of the fillet FI can be formed into an arc, so that the bonding strength between the first member ME1 and the second member ME2 can be further improved.

The bonding step includes S10 as a first step, S12 and S14 as a second step, and S16 as a third step. In S14, the fillet shaping die 10 and the first member ME1 are disposed with respect to the second member ME2 in which the adhesive GL is disposed so that the fillet shaping face 11 abuts the first member ME1 and the counter face 12 abuts the second member ME2. According to this bonding step, since the fillet FI is formed by the fillet shaping die 10, variations in the shapes of the fillet FI formed on the adhesive GL can be reduced.

Further, in the bonding step, in S12, the fillet shaping die 10 is temporarily fixed so that the fillet shaping face 11 abuts against the first member ME1. Thereafter, in S14, the second member ME2 is brought closer to the first member ME1 in which the adhesive GL is disposed until the second member ME2 abuts against the counter face 12. As described above, by temporarily fixing the fillet shaping die 10 in S12, the positional accuracy of the second member ME2 with respect to the first member ME1 can be improved.

### B. Second Embodiment

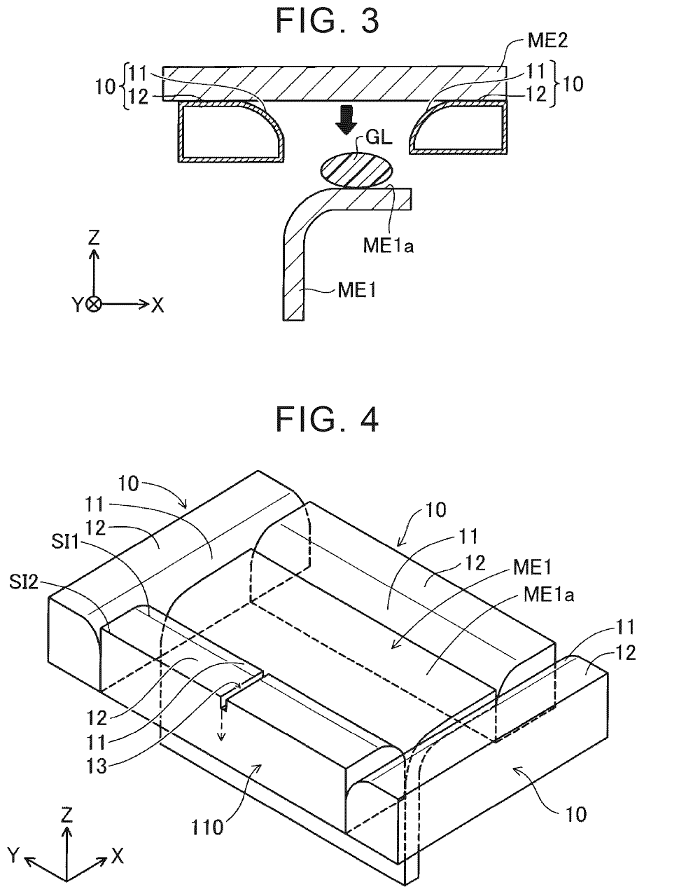

FIG. 3 is a diagram for explaining a bonding step of the second embodiment. The same components as those in the first embodiment are denoted by the same reference numerals, and only the difference portion will be described. In S10 of the bonding step of the first embodiment, the two fillet shaping dies 10 are temporarily fixed to the first member ME1. In contrast, in the present embodiment, as shown in FIG. 3, the two fillet shaping dies 10 are temporarily fixed to the second member ME2. In the present embodiment, the two fillet shaping dies 10 are positioned with respect to the second member ME2 such that the distance between the two fillet shaping faces 11 of the two fillet shaping dies 10 is the width of the first member ME1 in the X-direction.

After the two fillet shaping dies 10 are temporarily fixed to the second member ME2, the adhesive GL is disposed on the bonding face ME1a of the first member ME1. Thereafter, the second member ME2 is moved until the first member ME1 abuts against the fillet shaping face 11 so that the second member ME2 approaches the first member ME1.

According to the second embodiment described above, it is possible to easily perform the positioning of the second member ME2 in the plane of the first member ME1 with respect to the second member ME2.

### C. Third Embodiment

FIG. 4 is a diagram illustrating a fillet shaping die 110 according to the third embodiment. The same components as those in the first embodiment are denoted by the same reference numerals, and the detailed description thereof will be omitted as appropriate. In the bonding step of the present embodiment, three fillet shaping dies 10 having the same structure as the fillet shaping die 10 of the first embodiment are used, and one fillet shaping die 110 having a structure different from that of the fillet shaping die 10 of the first embodiment is used.

The fillet shaping die 110 is different from the fillet shaping die 10 of the first embodiment in that it has a groove 13. The groove 13 extends from the first side SI1 to the second side SI2 of the counter face 12. In the present embodiment, the groove 13 is formed on the counter face 12 at the substantially center of the fillet shaping die 110 in the axial direction. The groove 13 is formed in the counter face 12 along the width direction of the counter face 12 orthogonal to the axial direction of the fillet shaping die 110.

Note that the shape of the groove 13 is not limited to the shape shown in FIG. 4. For example, a plurality of grooves 13 may be formed in the counter face 12. The extending direction of the groove 13 is not limited to the width direction orthogonal to the axial direction of the fillet shaping die 110, and may be inclined with respect to the width direction. Further, the bottom surface of the groove 13 may be inclined such that the bottom position in the second side SI2 is located below the bottom position in the first side SI1. According to this configuration, as will be described later, when the excess adhesive GL flows through the groove 13, the adhesive GL can easily flow toward the second side SI2.

In the bonding step of the present embodiment, three fillet shaping dies 10 and one fillet shaping die 110 are arranged so as to surround the first member ME1. The arrangement is similar to that of the first embodiment, in which the respective fillet shaping faces 11 of the three fillet shaping dies 10 and one fillet shaping die 110 are arranged to abut the first member ME1. In the present embodiment, the first member ME1 is rectangular in plan view when viewed along the Z-direction. Therefore, the respective fillet shaping faces 11 of the three fillet shaping dies 10 and the one fillet shaping die 110 are arranged so as to draw a rectangle in a plan view.

Subsequent steps are also performed in the same manner as in the first embodiment. That is, after the three fillet shaping dies 10 and the one fillet shaping die 110 are temporarily fixed to the first member ME1, the adhesive GL is disposed on the bonding face ME1a. Thereafter, when the second member ME2 is brought close until abutting the counter face 12, the excess adhesive GL flows into the channel 13. The excess adhesive GL that has flowed into the groove 13 flows along the groove 13 toward the second side SI2, and hangs downward from the second side SI2 as indicated by a broken-line arrow. Therefore, it is preferable that a container for accommodating a hanging adhesive GL is disposed below the groove 13.

According to the third embodiment described above, in the bonding step, the three fillet shaping dies 10 and the one fillet shaping die 110 are arranged so as to surround the first member ME1. Therefore, the fillet FI can be formed in the entire area of the periphery in a plan view on the adhesive GL that bonds the first member ME1 and the second member ME2. Further, since the groove 13 is formed in the fillet shaping die 110, the excess adhesive GL flows into the groove 13. Therefore, it is possible to further reduce the possibility that the excess adhesive GL adheres to the first member ME1 or the second member ME2.

### D. Other Embodiments

(D1) In the bonding step of the first embodiment, two fillet shaping dies 10 are used. The number of fillet shaping dies 10 used in the bonding step is not limited to two, and may be one. By using the at least one fillet shaping die 10, the fillet FI can be formed on a portion of the bonding portion between the first member ME1 and the second member ME2.
(D2) The fillet shaping die 10 of the first embodiment includes a fillet shaping face 11 and a counter face 12. In other embodiments, the fillet shaping die 10 may comprise a fillet shaping face 11 and not a counter face 12. In this configuration, the fillet shaping die 10 is disposed so that the fillet shaping face 11 abuts on each of the first member ME1 and the second member ME2, whereby the fillet FI can be formed on the adhesive GL. Note that, as in the first embodiment, a configuration in which the fillet shaping die 10 includes the counter face 12 is preferable because the second member ME2 can be stably disposed by abutting the second member ME2 on the counter face 12. For the same reason, in the first embodiment, the counter face 12 is connected to one of the two end portions of the fillet shaping face 11, but the configuration may be such that the counter face 12 is provided on both of the two end portions of the fillet shaping face 11.
(D3) The fillet shaping die 10 of the first embodiment has a cylindrical shape. The shape of the fillet shaping die 10 is not limited to a cylindrical shape, and may be a solid columnar shape, or may be a plate shape including the fillet shaping face 11 and the counter face 12.
(D4) In the first embodiment, the shape of the curved face of the fillet shaping face 11 in a side view is an arc, but the shape is not limited to this. For example, the shape of the fillet shaping face 11 in a side view may be a shape in which a plurality of curves having different curvatures are connected to each other. Further, in the above-described embodiment, the entire area of the fillet shaping face 11 is a curved face for forming the fillet FI of the adhesive GL at the corner formed by the first member ME1 and the second member ME2. In another embodiment, a portion of the fillet shaping face 11 may be a curved face that forms a fillet FI of an adhesive GL at a corner formed by the first member ME1 and the second member ME2. For example, the fillet shaping face 11 may be formed by combining a curved face and a flat surface.
(D5) In the first embodiment, the first member ME1 is an L-shaped member, and the second member ME2 is a flat plate. The shapes of the first member ME1 and the second member ME2 are not limited thereto. For example, the fillet shaping die 10 can also be used for a configuration in which the first member ME1 and the second member ME2 are each a flat plate and the second member ME2 is disposed on the first member ME1. Also, for example, the fillet shaping die 10 can be used in a configuration in which the first member ME1 is a cylinder, the second member ME2 is a flat plate, and the second member ME2 is disposed at an end portion of the first member ME1. The shape of the fillet shaping die 10 is not limited to an axially extending shape, and for example, when the first member ME1 is a cylinder, the shape may be an annular shape that matches the shape of the first member ME1.
(D6) In the first embodiment, the material of the first member ME1 and the second member ME2 is a carbon-fiber composite material, and the adhesive GL is a two-liquid epoxy-resin. The material of the first member ME1 and the second member ME2 and the material of the adhesive GL are not limited thereto. For example, the material of the first member ME1 and the second member ME2 may be a metallic material, a resinous material, or wood. The adhesive GL may be made of a silicone resin or a phenolic resin, or may be made of a thermoplastic resin or a thermosetting resin.

The present disclosure is not limited to each of the above embodiments, and can be realized by various configurations without departing from the spirit thereof. For example, the technical features of the embodiments corresponding to the technical features in the respective embodiments described in the Summary can be appropriately replaced or combined in order to solve some or all of the above-described problems. For example, the technical features of the embodiments corresponding to the technical features in the respective embodiments described in the Summary can be appropriately replaced or combined in order to achieve some or all of the above-described effects. Further, when the technical features are not described as essential in the present specification, these can be deleted as appropriate.

What is claimed is:

1. A fillet shaping die, comprising a fillet shaping face that is disposed abutting a first member, wherein the fillet shaping face includes a curved face that shapes a fillet of an adhesive at a corner that is created by the first member and a second member that is bonded to the first member by the adhesive.

2. The fillet shaping die according to claim 1, further comprising a counter face that is connected to the fillet shaping face, and that abuts the second member, wherein:
the fillet shaping die is fashioned extending in a direction in which the corner extends; and
a shape of the fillet shaping face is arcuate in a side view of the fillet shaping die, as viewed in the direction in which the corner extends.

3. The fillet shaping die according to claim 2, wherein the counter face includes a first side that is connected to the fillet shaping face, a second side on an opposite side from the first side, and a groove extending from the first side to the second side.

4. A bonding method of bonding a first member and a second member using a fillet shaping die that includes a fillet shaping face and a counter face that is connected to the fillet shaping face, the bonding method comprising:
a first step of disposing an adhesive on the first member;
a second step of disposing the fillet shaping die and the second member with respect to the first member on which the adhesive is disposed, such that the fillet shaping face abuts the first member and also the counter face abuts the second member; and
a third step of separating the fillet shaping die from the first member and the second member after the adhesive is cured and the first member and the second member are bonded to each other.

5. The bonding method according to claim 4, wherein, in the second step, the fillet shaping die is temporarily fixed such that the fillet shaping face abuts the first member, following which the second member is brought closer to the first member on which the adhesive is disposed until the second member abuts the counter face.
